(19) United States
(12) Patent Application Publication
(10) Pub. No.: US 2018/0307321 A1
(43) Pub. Date: Oct. 25, 2018

(54) Build Status of a Buildable Product

(71) Applicant: Microsoft Technology Licensing, LLC, Redmond, WA (US)

(72) Inventor: Matthew John McCloskey, Seattle, WA (US)

(73) Assignee: Microsoft Technology Licensing, LLC, Redmond, WA (US)

(21) Appl. No.: 15/899,258

(22) Filed: Feb. 19, 2018

Related U.S. Application Data
(62) Division of application No. 13/114,359, filed on May 24, 2011, now abandoned.

(51) Int. Cl. G06F 3/01

(52) U.S. Cl. CPC G06F 3/017; G06F 3/011

(57) ABSTRACT

Various embodiments provide techniques for implementing build status for a buildable product. In at least some embodiments, a portion of a product (e.g., a component and/or a subassembly) can be scanned and a diagnostic message can be output that provides an explanation of a relationship between the portion and another portion of the product. In at least some embodiments, a user can interact with build instructions for a product via physical gestures that are detected by an input device, such as a camera. Interaction with the build instructions can enable navigation through an instruction guide for the product (e.g., through steps in a build process) and can present views of the product at various stages of assembly and from different visual perspectives.

### RELATED APPLICATION

This application is a divisional of and claims priority to U.S. patent application Ser. No. 13/114,359, filed on 24 May 2011 and titled “Interactive Build Instructions,” the contents of which are incorporated in their entirety by reference herein.

### BACKGROUND

A product typically includes some form of instruction manual that provides guidelines for assembling and/or using the product. For example, a toy that includes multiple parts can be accompanied by an instruction manual that explains how the parts interrelate and that provides suggested ways for assembling the parts. While instruction manuals can be helpful in some situations, they are typically limited with respect to their usability during a build process. For example, for a product that includes multiple pieces, it can be difficult to navigate an instruction manual while attempting to assemble the pieces.

### SUMMARY

Various embodiments provide techniques for implementing build status for a buildable product. In at least some embodiments, a portion of a product (e.g., a component and/or a subassembly) can be scanned and a diagnostic message can be output that provides an explanation of a relationship between the portion and another portion of the product. In at least some embodiments, a user can interact with build instructions for a product via physical gestures that are detected by an input device, such as a camera. Interaction with the build instructions can enable navigation through an instruction guide for the product (e.g., through steps in a build process) and can present views of the product at various stages of assembly and from different visual perspectives.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment that is operable to employ techniques for interactive build instructions in accordance with one or more embodiments.

FIG. 2 is an illustration of an example system that is operable to employ techniques for interactive build instructions in accordance with one or more embodiments.

FIG. 3 is an illustration of an example build instruction interaction in which a build instruction for a product can be viewed in accordance with one or more embodiments.

FIG. 4 is an illustration of an example build instruction interaction in which a build instruction for a product can be manipulated in accordance with one or more embodiments.

FIG. 5 is an illustration of an example build instruction interaction in which a build instruction for a product can be zoomed in accordance with one or more embodiments.

FIG. 6 is an illustration of an example build instruction interaction in which an exploded view of a build instruction for a product can be viewed in accordance with one or more embodiments.

FIG. 7 is an illustration of an example build instruction interaction in which an exploded view of a build instruction for a product can be manipulated in accordance with one or more embodiments.

FIG. 8 is an illustration of an example build instruction interaction in which a diagnostic mode can be used to determine a build status of a product in accordance with one or more embodiments.

FIG. 9 is an illustration of an example build instruction interaction in which a zoomed view of a product diagnostic can be viewed in accordance with one or more embodiments.

FIG. 10 is an illustration of an example build instruction interaction in which a relationship between product components can be viewed in accordance with one or more embodiments.

FIG. 11 is an illustration of an example build instruction interaction in which a zoomed version of a relationship between product components can be viewed in accordance with one or more embodiments.

FIG. 12 illustrates an example method for instruction guide navigation in accordance with one or more embodiments.

FIG. 13 illustrates an example method for obtaining build instructions in accordance with one or more embodiments.

FIG. 14 illustrates an example method for performing a product diagnostic in accordance with one or more embodiments.

FIG. 15 illustrates an example method for determining a relationship between portions of a product in accordance with one or more embodiments.

FIG. 16 illustrates an example device that can be used to implement techniques for build status for a buildable product in accordance with one or more embodiments.

### DETAILED DESCRIPTION

Overview

Various embodiments provide techniques for implementing build status for a buildable product. In at least some embodiments, a user can interact with build instructions for a product via physical gestures that are detected by an input device, such as a camera. Interaction with the build instructions can enable navigation through an instruction guide for the product (e.g., through steps in a build process) and can present views of the product at various stages of assembly and from different visual perspectives. Further to one or more embodiments, a portion of a product (e.g., a component and/or a subassembly) can be scanned and a diagnostic message can be output that provides an explanation of a relationship between the portion and another portion of the product.

As just one example, consider the following implementation scenario. A user receives a toy as a gift and the toy comes disassembled as multiple components in a package. The user presents the package to an input device (e.g., a camera) and the input device scans the package to determine product identification information. For example, the package can include a barcode or other suitable identifier that can be used to retrieve identification information. The product identification information is then used to retrieve an instruction guide for the toy, such as from a web server associated with a manufacturer of the toy.

Further to this example scenario, a page of the instruction guide (e.g., an introduction page) is displayed, such as via a television screen. The user can then navigate through the instruction guide using physical gestures (e.g., hand gestures, finger gestures, arm gestures, head gestures, and so on) that are sensed by an input device. For example, the user can move their hand in one direction to progress forward in the instruction guide, and the user can move their hand in a different direction to move backward through the instruction guide. Examples of other gesture-related interactions are discussed in more detail below. Thus, the user can interact with the instruction guide using intuitive gestures to view build instructions from a variety of visual perspectives.

Further, while examples are discussed herein with reference to particular gestures and/or combinations of gestures, these are presented for purposes of illustration only and are not intended to be limiting. Accordingly, it is to be appreciated that in at least some embodiments, another gesture and/or combination of gestures can be substituted for a particular gesture and/or combination of gestures to indicate specific commands and/or parameters without departing from the spirit and scope of the claimed embodiments.

In the discussion that follows, a section entitled “Operating Environment” is provided and describes an environment in which one or more embodiments can be employed. Following this, a section entitled “Example System” describes a system in which one or more embodiments can be employed. Next, a section entitled “Example Build Instruction Interactions” describes example interactions with build instructions in accordance with one or more embodiments. Following this, a section entitled “Example Methods” describes example methods in accordance with one or more embodiments. Last, a section entitled “Example System” describes an example system that can be utilized to implement one or more embodiments.

Operating Environment

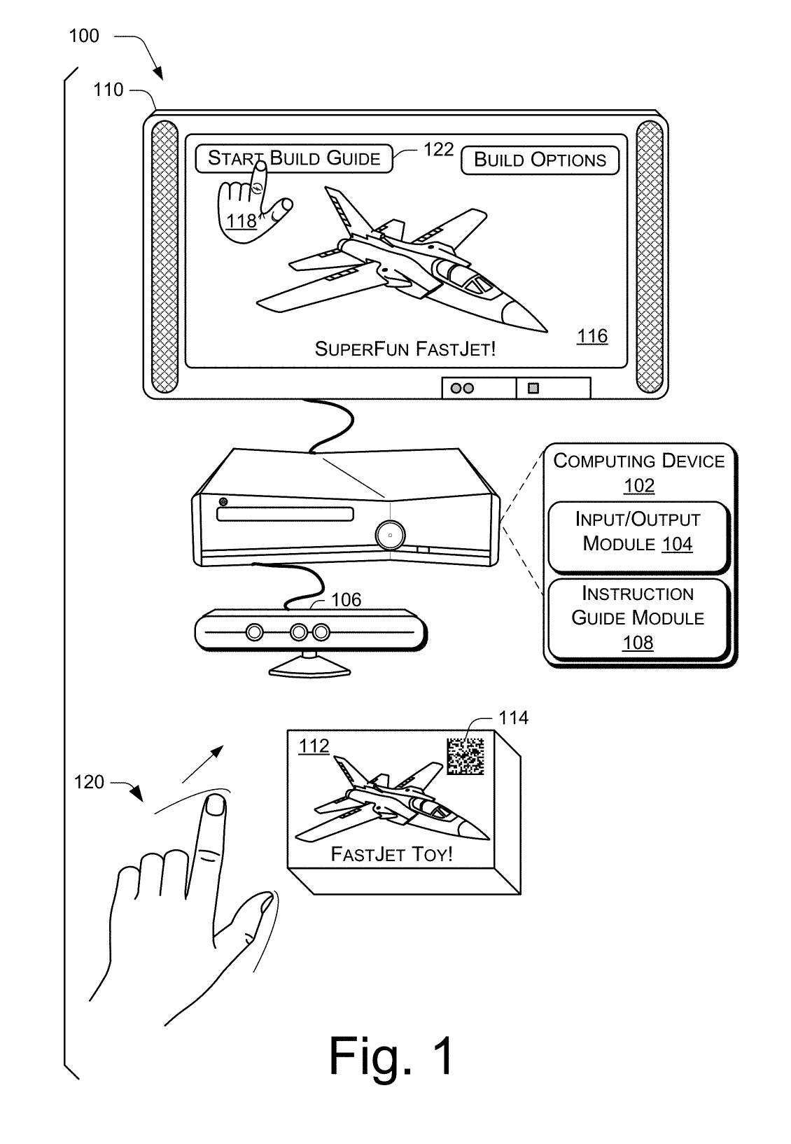

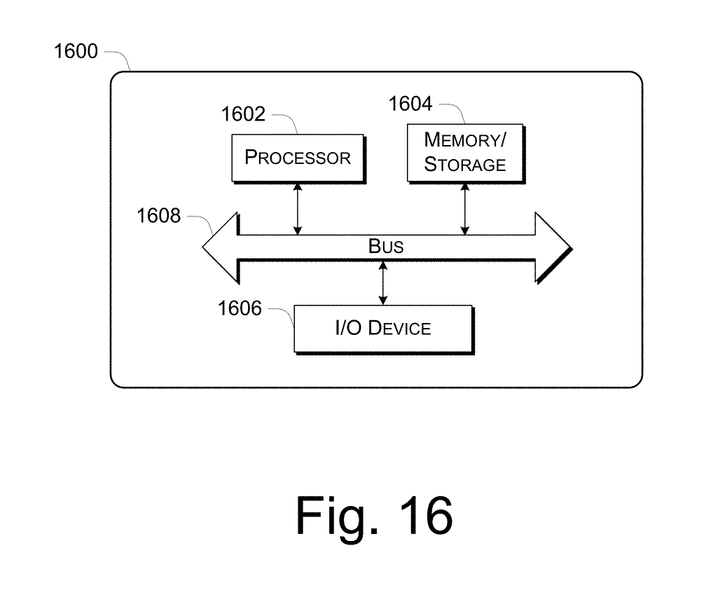

FIG. 1 illustrates an operating environment in accordance with one or more embodiments, generally at 100. Operating environment 100 includes a computing device 102 that can be configured in a variety of ways. For example, computing device 102 can be embodied as any suitable computing device such as, by way of example and not limitation, a game console, a desktop computer, a portable computer, a handheld computer such as a personal digital assistant (PDA), cell phone, and the like. One example configuration of the computing device 102 is shown and described below in FIG. 16.

Included as part of the computing device 102 is an input/output module 104 that represents functionality for sending and receiving information. For example, the input/output module 104 can be configured to receive input generated by an input device, such as a keyboard, a mouse, a touchpad, a game controller, an optical scanner, and so on. The input/output module 104 can also be configured to receive and/or interpret input received via a touchless mechanism, such as via voice recognition, gesture-based input, object scanning, and so on. Further to such embodiments, the computing device 102 includes a natural user interface (NUI) device 106 that is configured to receive a variety of touchless input, such as via visual recognition of human gestures, object scanning, voice recognition, color recognition, and so on.

In at least some embodiments, the NUI device 106 is configured to recognize gestures, objects, images, and so on via cameras. An example camera, for instance, can be configured with lenses, light sources, and/or light sensors such that a variety of different phenomena can be observed and captured as input. For example, the camera can be configured to sense movement in a variety of dimensions, such as vertical movement, horizontal movement, and forward and backward movement, e.g., relative to the NUI device 106. Thus, in at least some embodiments the NUI device 106 can capture information about image composition, movement, and/or position. The input/output module 104 can utilize this information to perform a variety of different tasks.

For example, the input/output module 104 can leverage the NUI device 106 to perform skeletal mapping along with feature extraction with respect to particular points of a human body (e.g., different skeletal points) to track one or more users (e.g., four users simultaneously) to perform motion analysis. In at least some embodiments, feature extraction refers to the representation of the human body as a set of features that can be tracked to generate input. For example, the skeletal mapping can identify points on a human body that correspond to a left hand. The input/output module 104 can then use feature extraction techniques to recognize the points as a left hand and to characterize the points as a feature that can be tracked and used to generate input. Further to at least some embodiments, the NUI device 106 can capture images that can be analyzed by the input/output module 104 to recognize one or more motions and/or positioning of body parts or other objects made by a user, such as what body part is used to make the motion as well as which user made the motion.

In implementations, a variety of different types of gestures may be recognized, such as gestures that are recognized from a single type of input as well as gestures combined with other types of input, e.g., a hand gesture and voice input. Thus, the input/output module 104 can support a variety of different gestures and/or gesturing techniques by recognizing and leveraging a division between inputs. It should be noted that by differentiating between inputs of the NUI device 106, a particular gesture can be interpreted in a variety of different ways when combined with another type of input. For example, although a gesture may be the same, different parameters and/or commands may be indicated when the gesture is combined with different types of inputs. Additionally or alternatively, a sequence in which gestures are received by the NUI device 106 can cause a particular gesture to be interpreted as a different parameter and/or command. For example, a gesture followed in a sequence by other gestures can be interpreted differently than the gesture alone.

Further included as part of the computing device 102 is an instruction guide module 108 that represents functionality for retrieving and/or interacting with an instruction guide. In at least some embodiments, the instruction guide module 108 is configured to receive input from the input/output module 104 to implement techniques discussed herein, such as retrieving and/or interacting with build instructions included as part of an instruction guide.

Operating environment 100 further includes a display device 110 that is coupled to the computing device 102. In at least some embodiments, the display device 110 is configured to receive and display output from the computing device 102, such as build instructions that are retrieved by the instruction guide module 108 and provided to the display device 110 by the input/output module 104. In implementations, the input/output module 104 can receive input from the NUI device 106 and can utilize the input to enable a user to interact with a user interface associated with the instruction guide module 108 that is displayed on the display device 110.

For example, consider the following implementation scenario. A user obtains a product 112 and presents the product to the NUI device 106, which scans the product and recognizes an identifier 114 for the product. For example, the product 112 can include packaging material (e.g. a box) in which the product is packaged and/or sold and on which the identifier 114 is affixed. Additionally or alternatively, one or more components (e.g., parts) of the product 112 can be presented to the NUI device 106 to be scanned. In at least some embodiments, “presenting” the product 112 to the NUI device 106 can include placing the product 112 in physical proximity to the NUI device such that the NUI device can scan the product 112 using one or more techniques discussed herein.

Further to the implementation scenario, the NUI device 106 ascertains identification information from the identifier 114, which it forwards to the instruction guide module 108. The instruction guide module 108 uses the identification information to obtain an instruction guide for the product 112, such as by submitting the identification information to a web resource associated with a manufacturer of the product 112.

Further to the example implementation, the instruction guide module 108 outputs an interface for the instruction guide for display via the display device 110, such as a start page 116 associated with the instruction guide. A user can then interact with the instruction guide using a variety of different forms of input, such as via gestures, objects, and/or voice input that are recognized by the NUI device 106. In this particular example scenario, a cursor 118 is displayed which a user can manipulate via input to interact with the start page 116 and/or other aspects of the instruction guide. For example, the user can provide gestures that can move the cursor 118 to different locations on the display device 110 to select and/or manipulate various objects displayed thereon.

Further to this example scenario, the user provides a gesture 120 which is recognized by the NUI device 106. Based on the recognition of the gesture 120, the NUI device 106 generates output that causes the cursor 118 to select a start button 122 displayed as part of the start page 116. In at least some embodiments, selecting the start button 122 causes a navigation within the instruction guide, such as to a first step in a build process for the product 112. This particular scenario is presented for purposes of example only, and additional aspects and implementations of the operating environment 100 are discussed in detail below.

In the discussion herein, reference is made to components of a product. In at least some embodiments, a component is a physical component of a physical product (e.g., the product 112) that can be assembled and/or manipulated relative to other physical components of a product.

Having described an example operating environment, consider now a discussion of an example system in accordance with one or more embodiments.

Example System

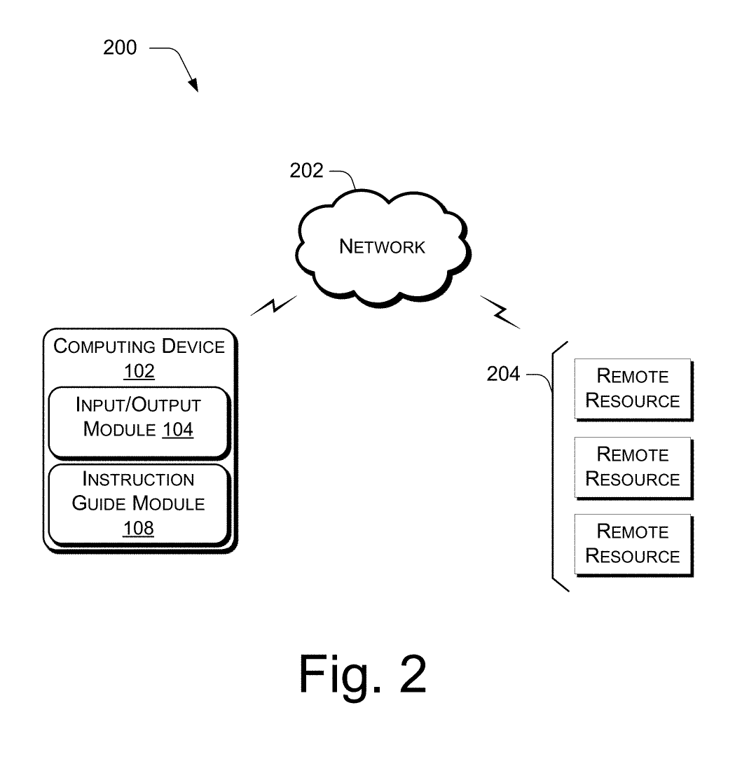

FIG. 2 illustrates an example system in which various techniques discussed herein can be implemented, generally at 200. In the example system 200, the computing device 102 is connected to a network 202 via a wired and/or wireless connection. Examples of the network 202 include the Internet, the web, a local area network (LAN), a wide area network (WAN), and so on. Also included as part of the example system 200 are remote resources 204 that are accessible to the computing device via the network 202. The remote resources 204 can include various types of data storage and/or processing entities, such as a web server, a cloud computing resource, a game server, and so on.

In at least some embodiments, various aspects of techniques discussed herein can be implemented using the remote resources 204. For example, instruction guide content and/or functionality can be provided by the remote resources 204 to the computing device 102. Thus, in certain implementations the computing device 102 can receive input from a user (e.g., via the NUI device 106) and can pass the input to the remote resources 204. Based on the input, the remote resources 204 can perform various functions associated with an instruction guide, such as retrieving build instructions, manipulating instruction guide images for display via the display device 110, locating updates for an instruction guide, and so on.

Thus, in at least some embodiments, the computing device 102 can be embodied as a device with limited data storage and/or processing capabilities (e.g., a smartphone, a netbook, a portable gaming device, and so on) but can nonetheless provide a user with instruction guide content and/or functionality by leveraging processing and storage functionalities of the remote resources 204.

Having described an example system, consider now a discussion of example build instruction interactions in accordance with one or more embodiments.

Example Build Instruction Interactions

This section discusses a number of example build instruction interactions that can be enabled by techniques discussed herein. In at least some embodiments, the example build instruction interactions can be implemented via aspects of the operating environment 100 and/or the example system 200, discussed above. Accordingly, certain aspects of the example build instruction interactions will be discussed with reference to features of the operating environment 100 and/or the example system 200. This is for purposes of example only, and aspects of the example build instruction interactions can be implemented in a variety of different operating environments and systems without departing from the spirit and scope of the claimed embodiments.

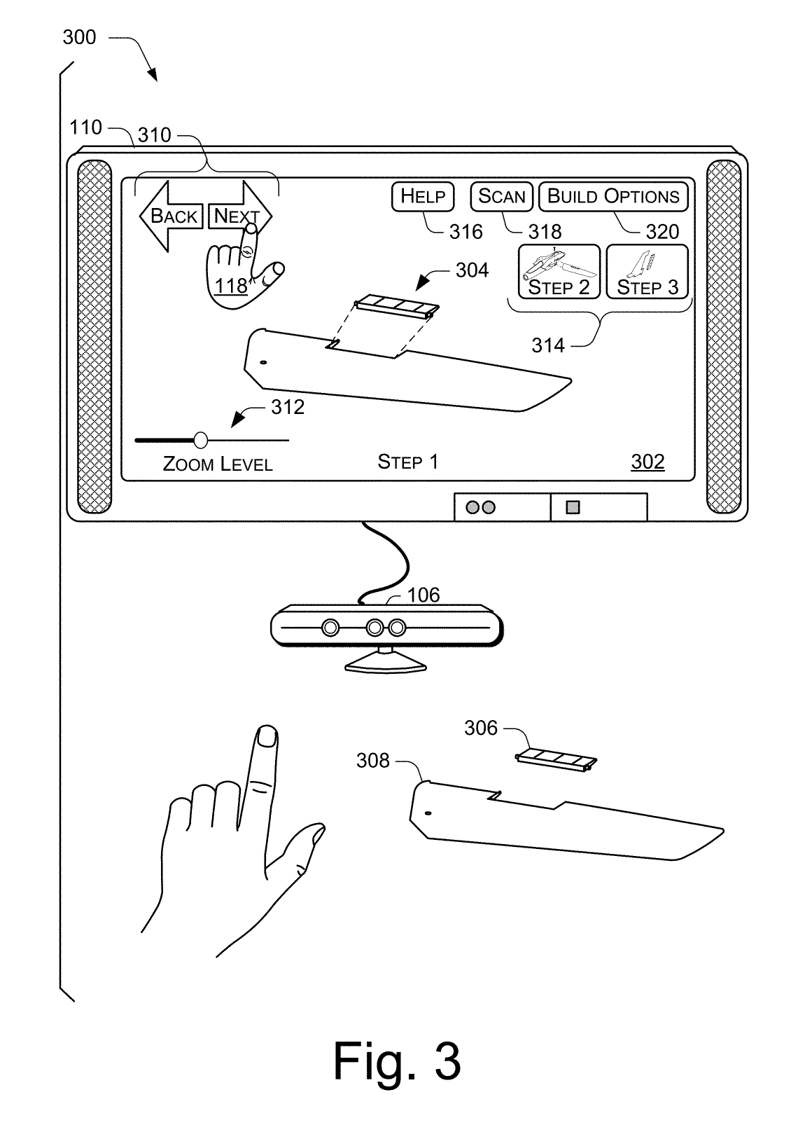

FIG. 3 illustrates an example build instruction interaction, generally at 300. As part of the build instruction interaction 300 is a build page 302 that is displayed via the display device 110. In at least some embodiments, the build page 302 is part of an instruction manual for a product, such as the product 112. The build page 302 represents a first step (e.g., “Step 1”) in a build process and can be displayed responsive to a selection of the start button 122 of the operating environment 100.

Included as part of the build page 302 is a diagram 304 that visually describes a relationship (e.g., a connectivity relationship) between a component 306 and a component 308. For example, the diagram 304 provides a visual explanation of how the component 306 and component 308 interrelate in the assembly of the product 112. The build page 302 also includes navigation buttons 310 that can be selected to navigate through pages of an instruction guide, such as forward and backward through steps of a build process.

Also included as part of the build page 302 is a zoom bar 312 that can be selected to adjust a zoom level of aspects of the build page 302, such as the diagram 304. For example, a user can provide gestures to move the cursor 118 to the zoom bar 312 and drag the cursor along the zoom bar to increase or decrease the zoom level.

The build page 302 further includes step icons 314 which each represent different steps in a build process and, in at least some embodiments, are each selectable to navigate to a particular step. The step icons 314 include visualizations of aspects of a particular step in the build process, such as components involved in a build step and/or a relationship between the components. In at least some embodiments, a user can provide gestures to scroll the step icons 314 forward and backward through steps and/or pages of an instruction guide. For example, the user can move the cursor 118 on or near the step icons 314. The user can then gesture in one direction (e.g., left) to scroll forward through the step icons 314 and can gesture in a different direction (e.g., right) to scroll backward through the step icons.

Further included as part of the build page 302 are a help button 316, a scan button 318, and an options button 320. The help button 316 can be selected (e.g., via gestures) to access a help functionality associated with a product and/or an instruction guide. In at least some embodiments, selecting the scan button 318 can cause a portion of a product (e.g., a component and/or a subassembly) to be scanned by the NUI device 106. Techniques for implementing a scan functionality are discussed in more detail below.

Further to at least some embodiments, the options button 320 can be selected to view build options associated with a product, such as the product 112. For example, a particular product can be associated with a number of build options whereby components associated with the product can be assembled in different ways to provide different build configurations. With reference to the product 112, components included with the product may be assembled to produce different configurations, such as a boat, a spaceship, a submarine, and so on. The options button 320 can be selected to view different product configurations and to access build instructions associated with the different product configurations.

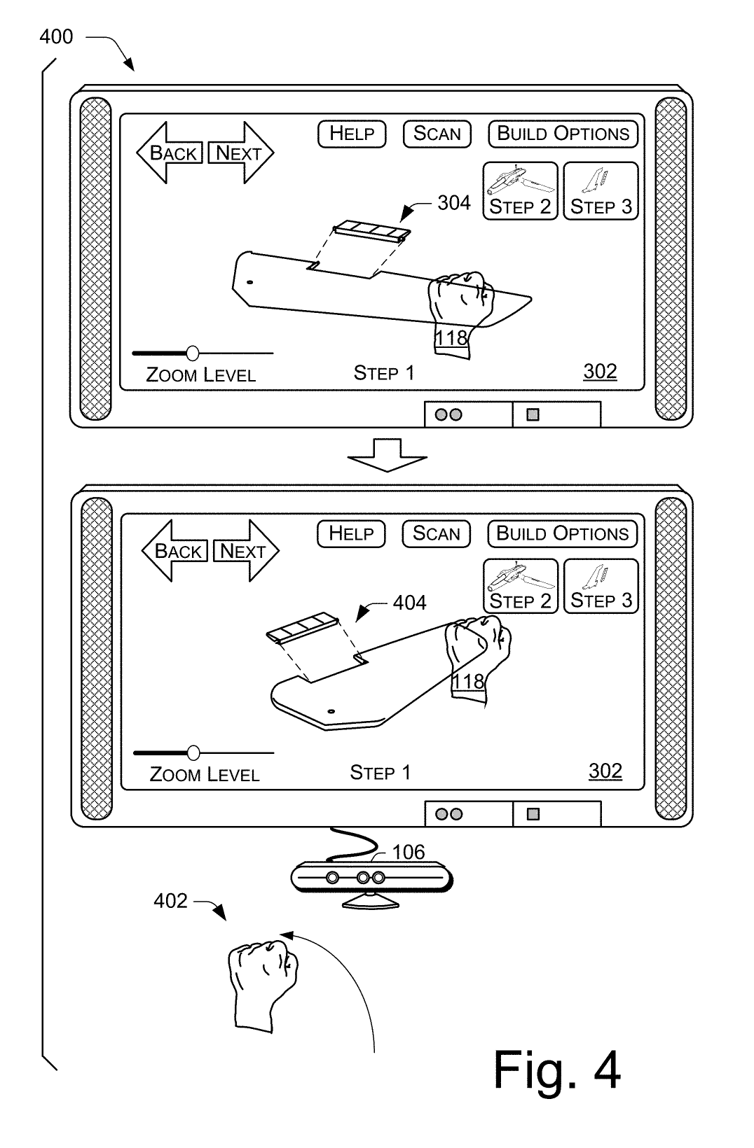

FIG. 4 illustrates another example build instruction interaction, generally at 400. In the build instruction interaction 400, a user moves the cursor 118 to the diagram 304 and provides a gesture 402 that the NUI device 106 identifies as a command to grab and rotate the diagram 304. For example, the user can move the cursor 118 to overlap the diagram 304 and then form a fist. The NUI device 106 can recognize this gesture and cause the cursor 118 to “grab” the diagram 304. When the cursor 118 has grabbed the diagram 304, subsequent user gestures can affect the position and/or orientation of the diagram 304. For example, by gesturing in different directions, the diagram 304 can be rotated according to different directions and orientations, such as around an x, y, and/or z axis relative to the diagram 304. In at least some embodiments, this can allow build steps and/or portions of a product to be viewed from different perspectives and provide information that can be helpful in building and/or using a product.

Further to the gesture 402, after the user causes the cursor 118 to grab the diagram 304, the user provides an arc gesture that is recognized by the NUI device 106, which then causes the diagram 304 to be rotated such that a rotated view 404 of the diagram 304 is presented.

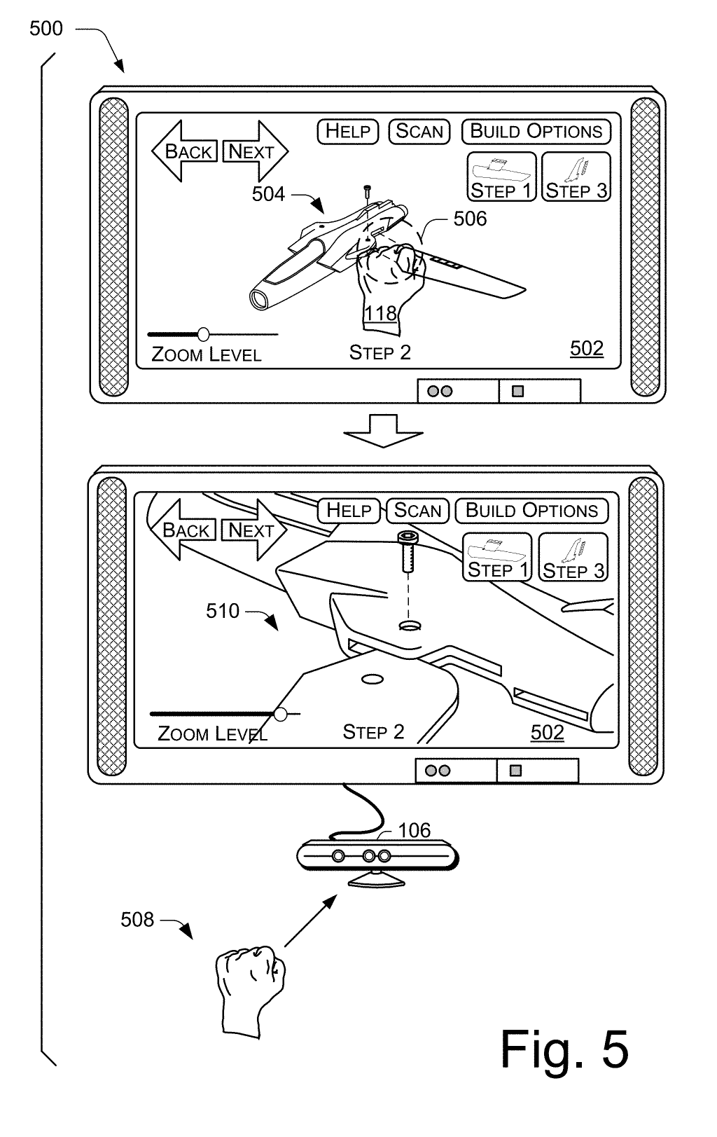

FIG. 5 illustrates another example build instruction interaction, generally at 500. The build instruction interaction 500 includes a build page 502 which corresponds to a particular step in a build process. For example, with reference to the examples discussed above, the build page 502 can correspond to a build step that is subsequent to the build step illustrated by build page 302. Included as part of the build page 502 is a diagram 504 that illustrates components associated with the particular step in the build process and a connectivity relationship between the components.

Also included as part of the build page 502 is a focus icon 506 that can be moved around the build page 502 to indicate a focus on different aspects of the diagram 504. In at least some embodiments, a user can provide gestures to move the focus icon 506 to a region of the diagram 504 to cause the region to be in focus. For example, the user can “grab” the focus icon 506 by moving the cursor 118 to the focus icon and closing their hand to form a fist. The NUI device 106 can recognize this input as grabbing the focus icon 506. The user can then move the focus icon to a region of the diagram 504 by moving their first to drag the focus icon 506 to the region.

Further to the build instruction interaction 500, the user moves the focus icon 506 to a region of the diagram 504. The user then provides a gesture 508, such as moving their first towards the NUI device 106. In at least some embodiments, the NUI device 106 recognizes this input as indicating a zoom operation, and thus the NUI device 106 outputs an indication of a zoom on the region of the diagram 504 that is in focus. Responsive to the indication of the zoom operation, the view of the diagram 504 is zoomed to the area in focus, as indicated by the zoom view 510. Thus, in at least some embodiments, a user can zoom in and out on a particular view and/or region of interest by gesturing towards and away from the NUI device 106, respectively.

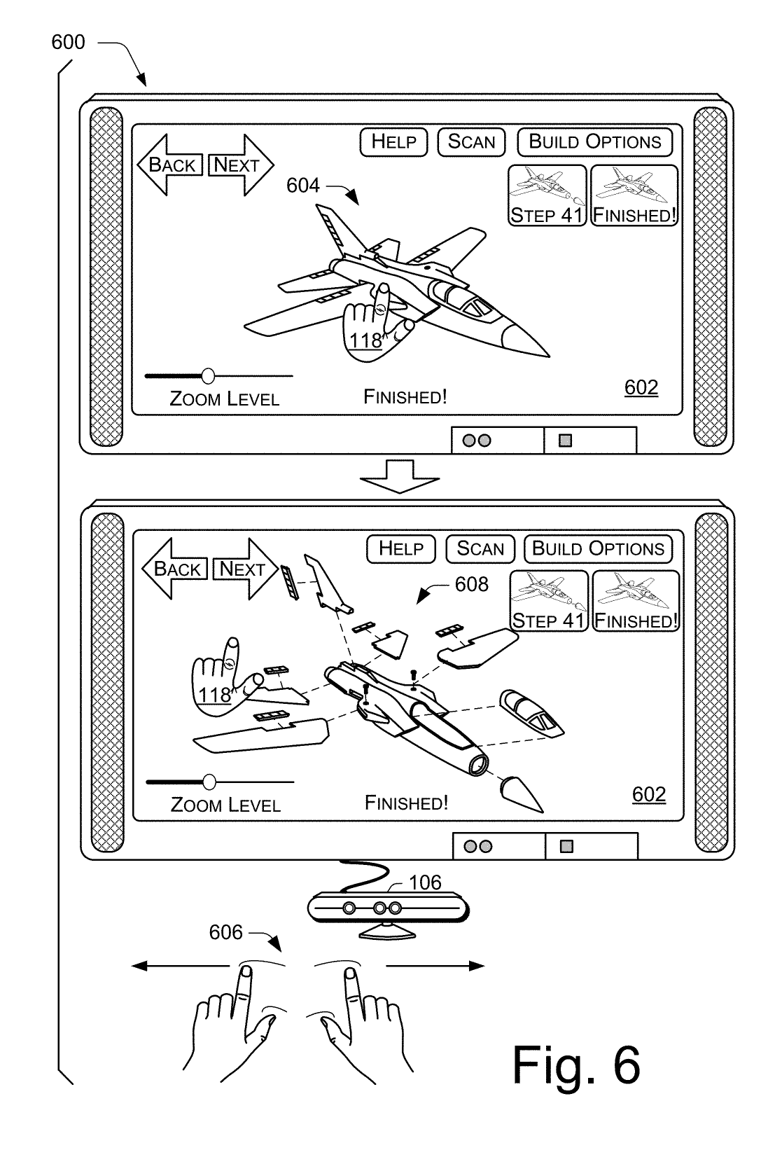

FIG. 6 illustrates another example build instruction interaction, generally at 600. The build instruction interaction 600 includes a build page 602, which corresponds to a particular step in a build process. Included as part of the build page 602 is a diagram 604, which corresponds to a view of a product as it appears at a particular point in a build process.

Further to the build instruction interaction 600, a user moves the cursor 118 to overlap the diagram 604. The user then provides a gesture 606, which in this example involves the user presenting two hands to the NUI device 106 and moving the hands apart, e.g., away from each other. The NUI device 106 recognizes this input as indicating an “explosion” operation, which indicates a request for an exploded view of the diagram 604. In at least some embodiments, an exploded view refers to a visual representation of a partial or total disassembly of a product into components and/or subassemblies. The exploded view can also include indicators of relationships between the components and/or subassemblies, such as connector lines, arrows, and so on.

Further to the build instruction interaction 600 and responsive to recognizing the gesture 606, the NUI device 106 outputs an indication of an explosion operation on the diagram 604, the results of which are displayed as an exploded view 608. In at least some embodiments, a user can focus on a particular region of the exploded view 608 (e.g., using the focus icon 506 discussed above) to zoom in on the region and/or to view further information about the region, such as a build step associated with components and/or subassemblies in the region.

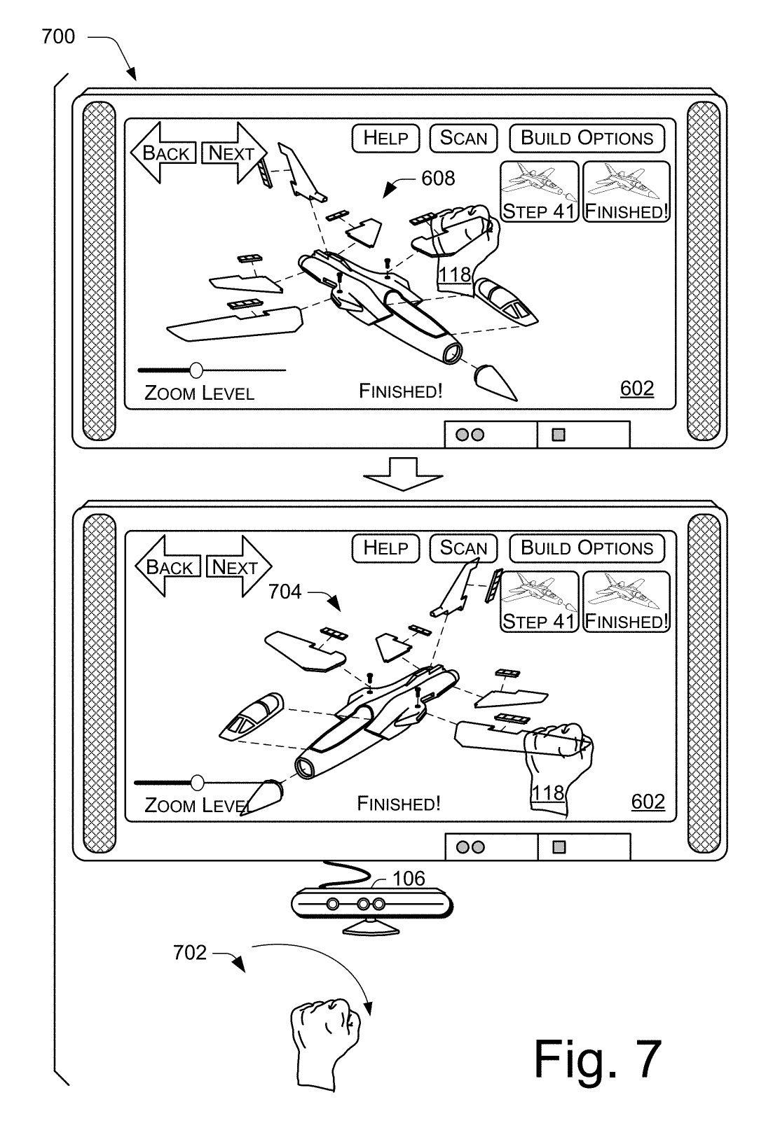

FIG. 7 illustrates another example build instruction interaction, generally at 700. The build instruction interaction 700 illustrates a rotate operation as applied to the exploded view 608, discussed above. As discussed with reference to FIG. 4, a user can “grab” an object that is displayed on the display device 110, such as a diagram or other aspect of a build guide. The user can then change the position and/or orientation of the displayed object using gestures.

For example, in the build instruction interaction 700, a user grabs the exploded view 608 and provides a gesture 702 to rotate the exploded view and provide a different perspective of the exploded view. As illustrated here, the different perspective is indicated as a rotated exploded view 704

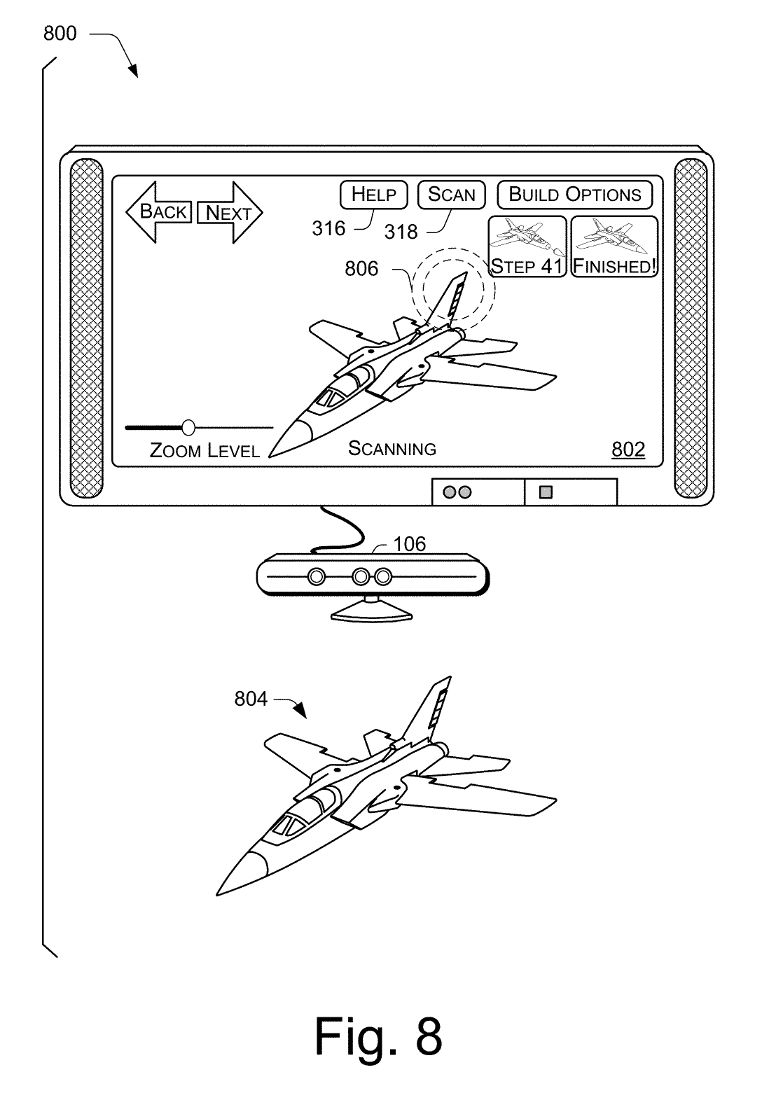

FIG. 8 illustrates another example build instruction interaction, generally at 800. As part of the build instruction interaction 800 is a diagnostic screen 802 that indicates that a build guide is currently in a diagnostic mode. In at least some embodiments, a user can activate a diagnostic mode of a build guide by pressing the help button 316 and/or the scan button 318. The user can then present an object to the NUI device 106 for scanning In this particular example, the NUI device 106 scans a product 804 to determine attributes of the product, such as a build status of the product.

In at least some embodiments, the build status of the product 804 can include an indication of a build progress of the product and/or an error that has occurred during a build process for the product. Further to the build instruction interaction 800, a build status of the product 804 indicates that an error has occurred during the build process. Responsive to this determination, a diagnostic 806 is displayed that includes a visual indication of a region of the product 804 associated with the error. Further details associated with diagnostic scanning are discussed below.

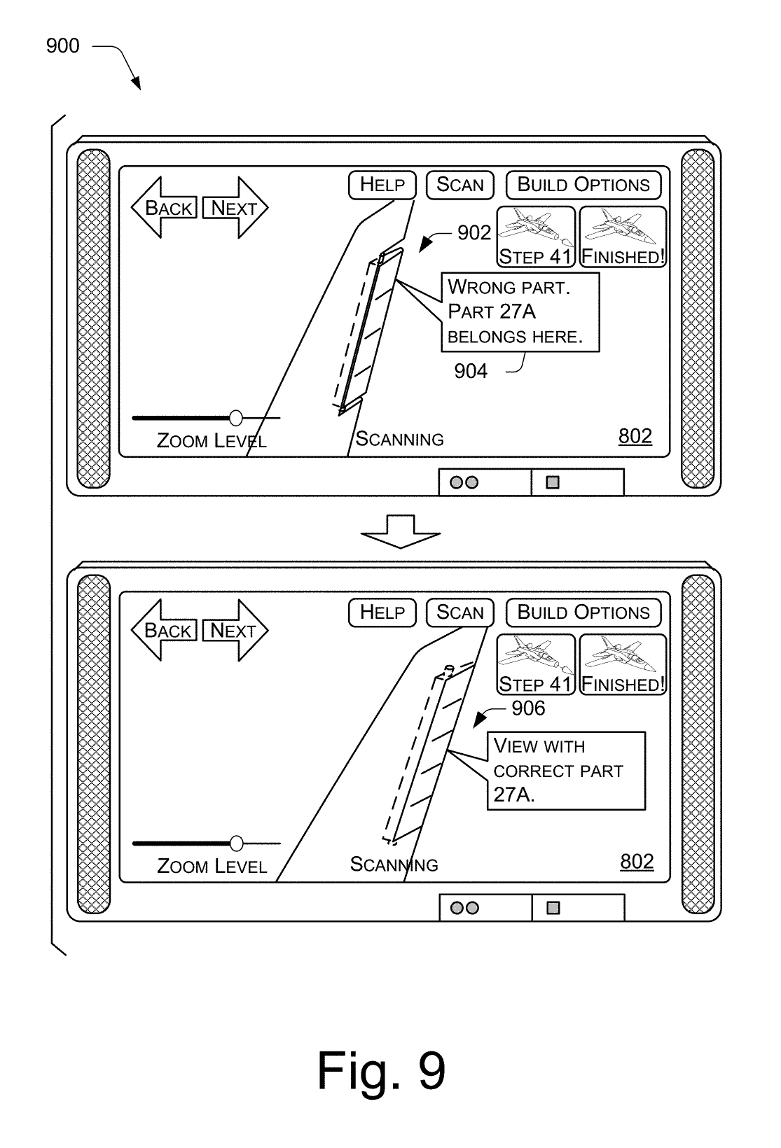

FIG. 9 illustrates another example build instruction interaction, generally at 900. Included as part of the build instruction interaction 900 and displayed on the diagnostic screen 802 is an error region 902 that presents a zoomed view of the region indicated by the diagnostic 806, discussed above. The diagnostic screen 802 also includes a diagnostic message 904 which presents information about the error region 902, such as an explanation of the error and information about a correct configuration for the region.

Further included as part of the build instruction interaction 900 is a corrected view 906 that presents a view of the error region 902 as it appears when correctly assembled. In at least some embodiments, a user can select the corrected view 906 (e.g., using gestures) to view more information about the corrected view, such as component numbers associated with corrected view, build steps associated with the corrected view, and so on.

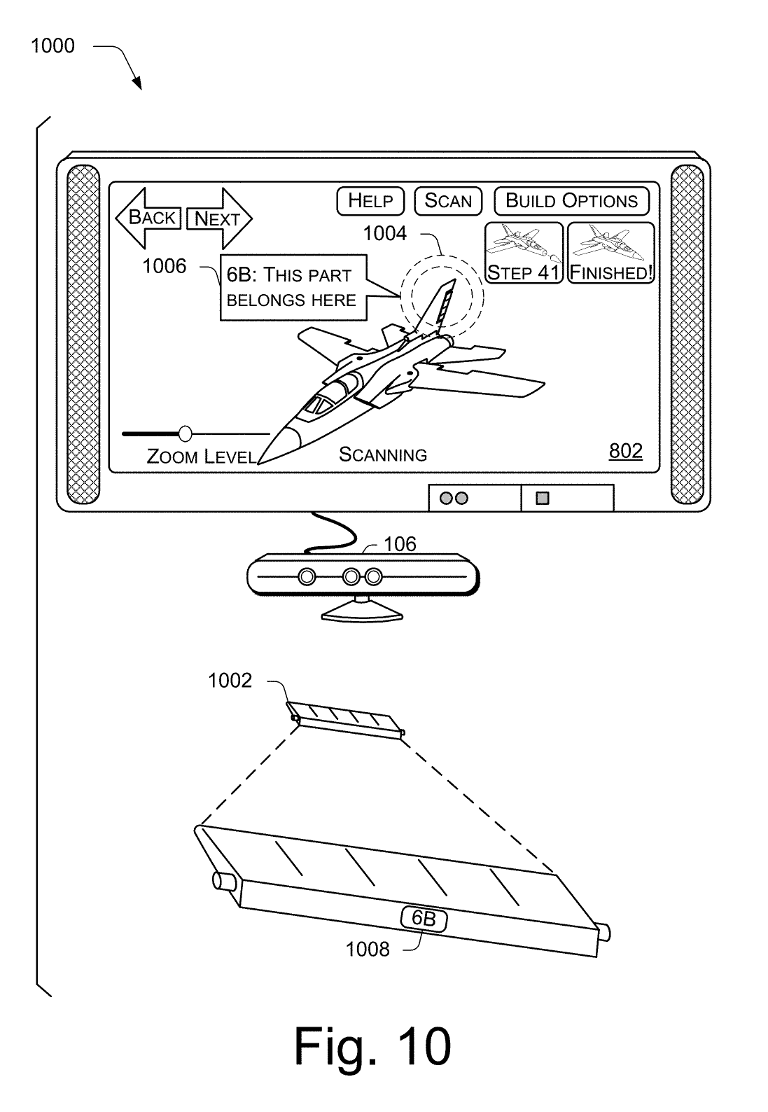

FIG. 10 illustrates another example build instruction interaction, generally at 1000. In the build instruction interaction 1000, a build guide is in a diagnostic mode (e.g., as discussed above) and a user presents a component 1002 to be scanned by the NUI device 106. In at least some embodiments, the component 1002 represents a piece and/or a subassembly of the product 804, discussed above. The NUI device 106 scans the component 1002 and outputs identification information for the component, e.g., to the instruction guide module 108. Examples of identification information include physical features of the component 1002 (e.g., a physical contour of the component), a barcode identifier, a radio frequency identification (RFID) identifier, a character identifier, and so on. Using the identification information for the component 1002, the instruction guide module 108 determines a relationship of the component 1002 to other components of the product 804 and outputs the relationship as a diagnostic 1004.

Also included as part of the build instruction interaction 1000 is a diagnostic message 1006 that includes information about the component 1002 and/or the diagnostic 1004, such as an identifier for the component, an explanation of a relationship between the component and other components of the product 804, build steps that are associated with the component, and so on.

In at least some embodiments, the NUI device 106 can also identify the component 1002 based on other types of input, such as voice recognition input, color recognition input, and so on. Further to such embodiments, the component 1002 includes a mark 1008 that can be read and spoken by a user to the NUI device 106. For example, a user can say “component number 6B”, and the NUI device 106 can recognize the input and can output an identifier for the component 1002 to be used to retrieve information about the component.

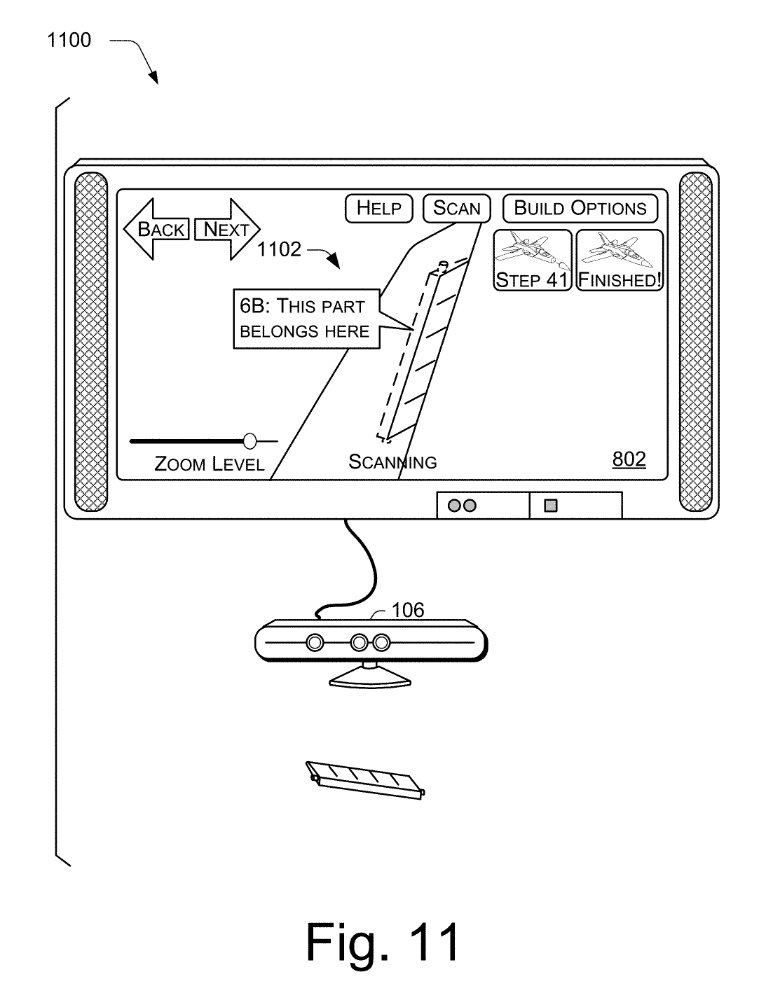

FIG. 11 illustrates another example build instruction interaction, generally at 1100. Included as part of the build instruction interaction 1100 is a diagnostic zoom 1102, which represents a zoomed view of the region associated with the diagnostic 1004, discussed above. In at least some embodiments, a user can manipulate the diagnostic zoom 1102 using gestures to zoom in and out of the diagnostic zoom 1102 and/or to rotate the region associated with the diagnostic zoom.

Having described example build instruction interactions, consider now a discussion of example methods in accordance with one or more embodiments.

Example Methods

The following discussion describes methods that can be implemented in accordance with one or more embodiments. Aspects of the methods can be implemented in hardware, firmware, software, or a combination thereof. The methods are shown as a set of blocks that specify operations performed by one or more devices and are not necessarily limited to the orders shown for performing the operations by the respective blocks. In portions of the following discussion, reference will be made to features and aspects of embodiments discussed elsewhere herein. For example, aspects of the methods can be implemented via interaction between the NUI device 106, the instruction guide module 108, and/or the input/output module 104.

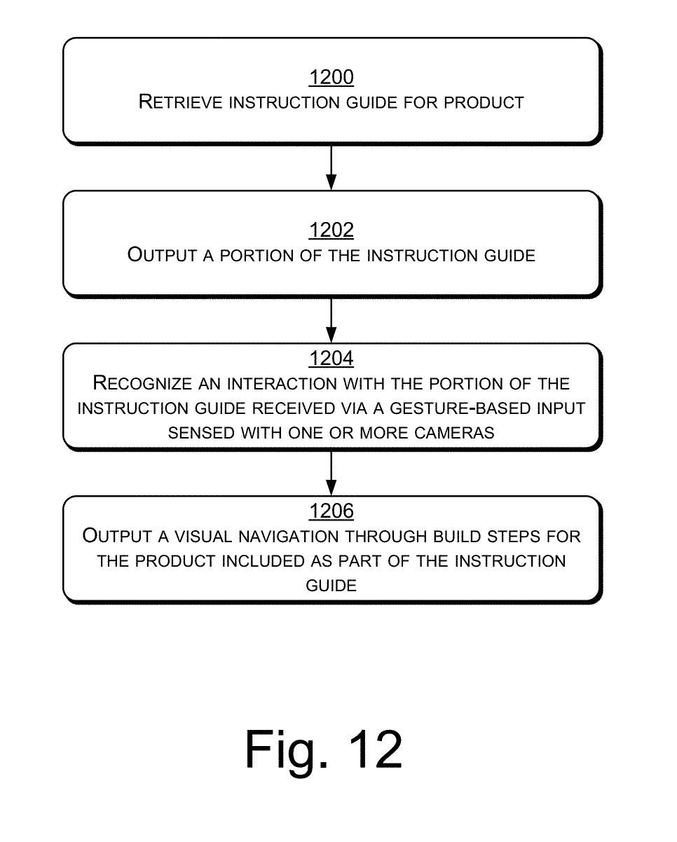

FIG. 12 is a flow diagram that describes steps a method for build instruction navigation in accordance with one or more embodiments. Step 1200 retrieves an instruction guide for a product. For example, an identifier for the product (e.g., the product 112) can be scanned using the NUI device 106 to determine identification information for the product. A variety of different identifiers and identifier scanning techniques can be utilized, such as barcode scanning, RFID scanning, object recognition scanning, fiber optic pattern scanning, and so on. The identification information can be used to retrieve the instruction guide, such as by submitting the identification information to a network resource associated with a manufacturer of the product (e.g., one of the network resources 204) and receiving the instruction guide from the network resource.

Step 1202 outputs a portion of the instruction guide. For example, a start page and/or an initial build step associated with the product can be output via the display device 110. Step 1204 recognizes an interaction with the portion of the instruction guide received via a gesture-based input sensed with one or more cameras. For example, a user can provide gestures that are sensed by the NUI device 106 and that are recognized by the instruction guide module 108 as an interaction with the portion of the instruction guide.

Step 1206 outputs a visual navigation through build steps for the product included as part of the instruction guide. In at least some embodiments, the visual navigation can be output in response to recognizing the interaction with the portion of the instruction guide. For example, gestures provided by a user can direct navigation through the instruction guide. In response to the user-directed navigation through the instruction guide, build steps associated with the product can be displayed that indicate relationships between components and/or subassemblies of the product.

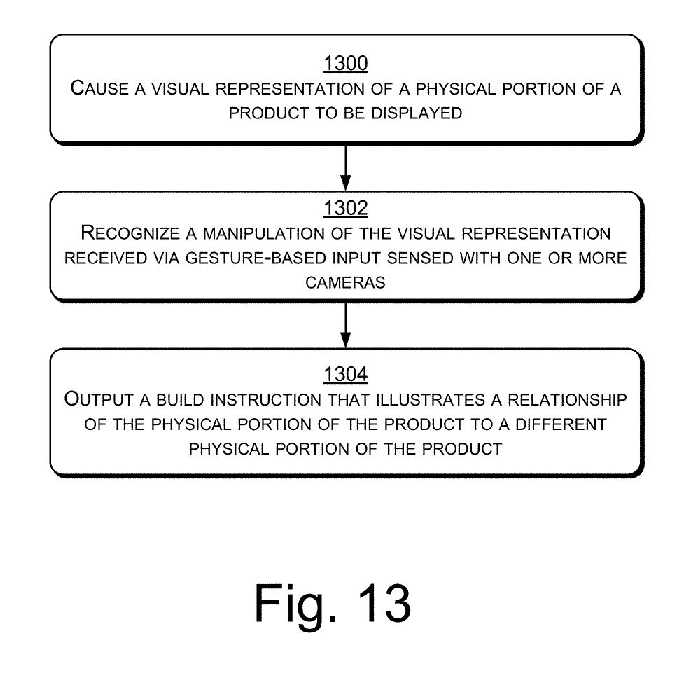

FIG. 13 is a flow diagram that describes steps a method for obtaining build information in accordance with one or more embodiments. Step 1300 causes a visual representation of a physical portion of a product to be displayed. For example, a visual representation of components, subassemblies, and/or a partially constructed version of a product can be displayed. Alternatively or additionally, a visual representation of a completed version of the product can be displayed.

Step 1302 recognizes a manipulation of the visual representation received via gesture-based input sensed with one or more cameras. In at least some embodiments, a user can “grab” the visual representation using gesture-based manipulation of a cursor and can manipulate the visual representation, such as by zooming the visual representation, rotating the visual representation, and so on. As a further example, a user can provide a gesture that indicates an explosion operation with respect to the visual representation, e.g., to present an exploded view of the portion of the product.

Step 1304 outputs a build instruction that illustrates a relationship of the physical portion of the product to a different physical portion of the product. In at least some embodiments, the build instruction can be output responsive to recognizing the manipulation of the visual representation. In example implementations, the build instruction can include indications of a connectivity relationship between components and/or subassemblies of the portion of the product. The build instruction can also include component identifiers and text instructions for assembling part and/or the entire product.

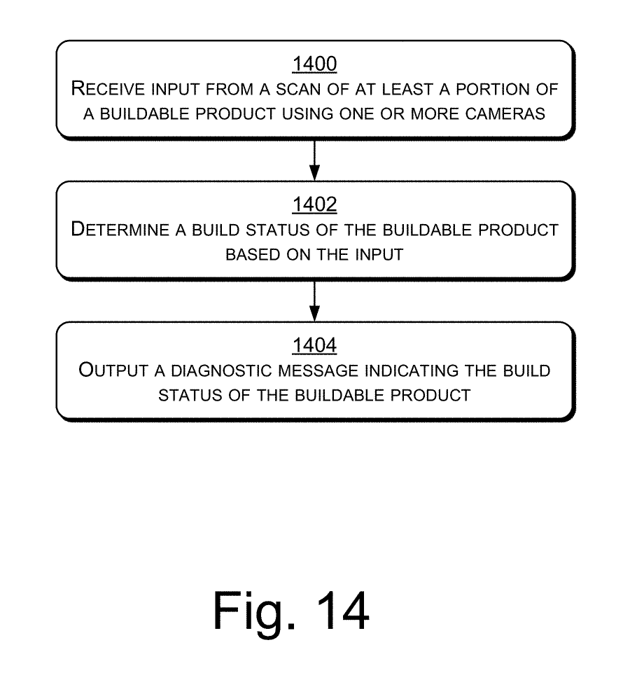

FIG. 14 is a flow diagram that describes steps a method for performing a product diagnostic in accordance with one or more embodiments. Step 1400 receives input from a scan of at least a portion of a buildable product using one or more cameras. For example, a physical component of a product can be scanned by the NUI device 106 to determine identification information for the component. The component can be recognized by the instruction guide module 108 based on the identification information.

Step 1402 determines a build status of the buildable product based on the input. In at least some embodiments, the input can indicate a connectivity relationship between parts of the product. For example, the connectivity relationship can refer to where a particular part is connected to the portion of the buildable product (e.g., what region of the portion) and/or to what part or parts a particular part is connected. Further to at least some embodiments, the build status can include an indication as to whether the connectivity relationship is correct with respect to build instructions for the product. For example, the build status can indicate that components of the product have been incorrectly attached during the build process.

As a further example, the build status can indicate a build step associated with the portion of the product. For example, the input from the scan can indicate that, based on features of the portion of the product, a build process that includes multiple steps for the product is at a particular step in the build process. For instance, the portion of the product can include parts that correspond to the fifth step in the build process, so the scan can indicate that the portion of the product corresponds to step 5 in the build process.

Step 1404 outputs a diagnostic message indicating the build status of the buildable product. For example, the diagnostic message can include an indication that components of the portion of the product are incorrectly assembled. The diagnostic message can also include an indication of a correct connectivity relationship between the components, such as relationship indicators and/or part numbers associated with the components. Additionally or alternatively, an indication of disassembly steps can be output that indicate how to disassemble an incorrectly assembled portion of the product such that the product can be correctly assembled.

Further to at least some embodiments, where the build status indicates a build step associated with the portion of the product, the diagnostic message can include an identification of the build step and/or can automatically navigate a build guide for the product to the build step.

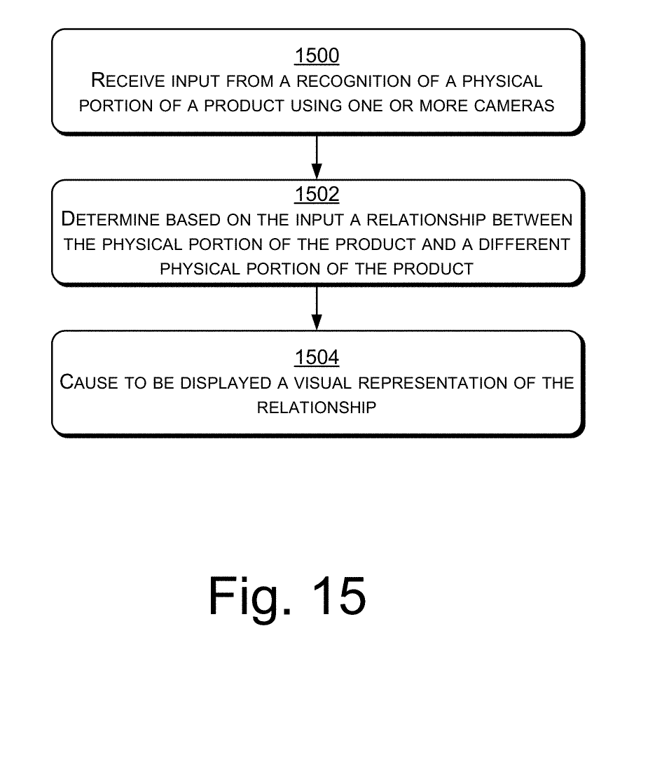

FIG. 15 is a flow diagram that describes steps in a method for determining a relationship between portions of a product in accordance with one or more embodiments. Step 1500 receives input from a recognition of a physical portion of a product using one or more cameras. For example, a component of the product can be scanned by the NUI device 106 and recognized by the instruction guide module 108 based on a feature of the component. Examples of a feature that can be used to recognize a component include physical features (e.g., a physical contour of the component), a barcode identifier, an RFID identifier, a character identifier, and so on.

Step 1502 determines, based on the input, a relationship between the physical portion of the product and a different physical portion of the product. For example, the relationship can include a connectivity relationship between the portion of the product and other portions of the product, such as an indication of how the portions fit together in a build process for the product. As a further example, the relationship can include an indication as to how the portion of the product relates to a fully assembled version of the product, such as a position and/or placement of the portion of the product in the assembled product. In at least some embodiments, the fully assembled version can be a correctly assembled version or an incorrectly assembled version, and the relationship can indicate that the fully assembled version is correct or incorrect.

Step 1504 causes to be displayed a visual representation of the relationship. For example, a visual indication of a connectivity relationship between the physical portion of the product and the different physical portion of the product in a build process for the product can be displayed.

Having described methods in accordance with one more embodiments, consider now an example device that can be utilized to implement one or more embodiments.

Example Device

FIG. 16 illustrates an example computing device 1600 that can be used to implement various embodiments described herein. Computing device 1600 can be, for example, computing device 102 and/or one or more of remote resources 204, as described above in FIGS. 1 and 2.

Computing device 1600 includes one or more processors or processing units 1602, one or more memory and/or storage components 1604, one or more input/output (I/O) devices 1606, and a bus 1608 that allows the various components and devices to communicate with one another. Bus 1608 represents one or more of any of several types of bus structures, including a memory bus or memory controller, a peripheral bus, an accelerated graphics port, and a processor or local bus using any of a variety of bus architectures. Bus 1608 can include wired and/or wireless buses.

Memory/storage component 1604 represents one or more computer storage media and can include volatile media (such as random access memory (RAM)) and/or nonvolatile media (such as read only memory (ROM), Flash memory, optical disks, magnetic disks, and so forth). Component 1604 can include fixed media (e.g., RAM, ROM, a fixed hard drive, etc.) as well as removable media (e.g., a Flash memory drive, a removable hard drive, an optical disk, and so forth).

One or more input/output devices 1606 allow a user to enter commands and information to computing device 1600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes applications, routines, programs, objects, components, data structures, and so forth that perform particular tasks or implement particular abstract data types. An implementation of these modules and techniques may be stored on or transmitted across some form of computer readable media, such as the memory/storage component 1604. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. While the computing device 1600 is configured to receive and/or transmit instructions via a signal bearing medium (e.g., as a carrier wave) to implement techniques discussed herein, computer-readable storage media of the computing device are configured to store information and thus do not consist only of transitory signals.

### CONCLUSION

Various embodiments provide techniques for implementing build status for a buildable product. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
one or more processors; and
one or more computer-readable storage media storing instructions that are executable by the one or more processors to perform operations including:
receiving input from a scan of at least a portion of a buildable product using one or more cameras;
determining a build status of the buildable product based on the input; and
outputting a diagnostic message indicating the build status of the buildable product.

2. A system as described in claim 1, wherein the build status indicates that the portion of the buildable product is a partially assembled version of the buildable product, and wherein the diagnostic message comprises a particular build step of multiple build steps in a build process for the buildable product, the particular build step indicating a point in the build process that corresponds to the partially assembled version of the buildable product.

3. A system as described in claim 1, wherein the portion of the buildable product includes components of the buildable product, and wherein the build status includes an indication that at least one of the components is incorrectly assembled.

4. A system as described in claim 1, wherein the portion of the buildable product includes components of the buildable product, and wherein the build status includes an indication that at least one of the components is incorrectly assembled, and wherein the diagnostic message includes an explanation of how the at least one of the components is incorrectly assembled and an indication of a correct connectivity relationship associated with the one or more components.

5. A system as described in claim 1, wherein the build status comprises a particular build step of multiple build steps in a build process for the buildable product, the particular build step corresponding to the portion of the buildable product, and wherein the operations further include automatically navigating a build guide for the buildable product to a portion of the build guide associated with the build step.

6. A system as described in claim 1, wherein the build status comprises a particular build step of multiple build steps in a build process for the buildable product, the particular build step corresponding to the portion of the buildable product, and wherein the operations further include:
automatically navigating a build guide for the buildable product to a portion of the build guide associated with the build step; and
enabling navigation through the build guide via a recognition of gesture-based input sensed via the one or more cameras.

7. A system as described in claim 1, wherein the operations further include:
causing a visual representation of the portion of the buildable product to be displayed;
recognizing a manipulation of the visual representation received via a gesture-based input sensed with the one or more cameras; and
changing a visual perspective of the visual representation responsive to the manipulation.

8. One or more computer-readable storage media comprising instructions that, when executed by a computing device, cause the computing device to:
receive input from a recognition of a physical portion of a product using one or more cameras;
determine based on the input a relationship between the physical portion of the product and a different physical portion of the product; and
cause to be displayed a visual representation of the relationship, the visual representation including a visual indication of a connectivity relationship between the physical portion of the product and the different physical portion of the product in a build process for the product.

9. One or more computer-readable storage media as described in claim 8, wherein the physical portion of the product comprises a component of the product, the different physical portion of the product comprises an assembled version of the product, and the visual indication of the connectivity relationship comprises a visual indication of how the component of the product relates to the assembled version of the product.

10. One or more computer-readable storage media as described in claim 8, wherein the instructions are further configured to, when executed by the computing device, cause the computing device to, responsive to receiving the input, automatically navigate to a portion of an instruction guide for the product associated with the relationship between the physical portion of the product and the different physical portion of the product.

11. One or more computer-readable storage media as described in claim 10, wherein the instructions are further configured to, when executed by the computing device, enable navigation through multiple portions of the instruction guide via a recognition of gesture-based input sensed with the one or more cameras.

12. One or more computer-readable storage media as described in claim 8, wherein the instructions are further configured to, when executed by the computing device, cause the computing device to:
recognize a manipulation of the visual representation received via a gesture-based input sensed with the one or more cameras; and
responsive to recognizing the manipulation, present one or more of a zoomed view, a rotated view, or an exploded view of the visual representation for display.

13. One or more computer-readable storage media as described in claim 8, wherein the visual indication of the connectivity relationship includes an indication that the physical portion of the product is incorrectly connected to the different physical portion of the product, and wherein the instructions are further configured to, when executed by the computing device, cause the computing device to output an indication of a correct connectivity relationship associated with one or more of the physical portion of the product or the different physical portion of the product.

14. A method comprising:
receiving input from a scan of at least a portion of a buildable product using one or more cameras;
determining a build status of the buildable product based on the input; and
outputting a diagnostic message indicating the build status of the buildable product.

15. A method as described in claim 14, wherein the build status indicates that the portion of the buildable product is a partially assembled version of the buildable product, and wherein the diagnostic message comprises a particular build step of multiple build steps in a build process for the buildable product, the particular build step indicating a point in the build process that corresponds to the partially assembled version of the buildable product.

16. A method as described in claim 14, wherein the portion of the buildable product includes components of the buildable product, and wherein the build status includes an indication that at least one of the components is incorrectly assembled.

17. A method as described in claim 14, wherein the portion of the buildable product includes components of the buildable product, and wherein the build status includes an indication that at least one of the components is incorrectly assembled, and wherein the diagnostic message includes an explanation of how the at least one of the components is incorrectly assembled and an indication of a correct connectivity relationship associated with the one or more components.

18. A method as described in claim 14, wherein the build status comprises a particular build step of multiple build steps in a build process for the buildable product, the particular build step corresponding to the portion of the buildable product, and wherein the method further comprises automatically navigating a build guide for the buildable product to a portion of the build guide associated with the build step.

19. A method as described in claim 14, wherein the build status comprises a particular build step of multiple build steps in a build process for the buildable product, the particular build step corresponding to the portion of the buildable product, and wherein the method further comprises:
automatically navigating a build guide for the buildable product to a portion of the build guide associated with the build step; and
enabling navigation through the build guide via a recognition of gesture-based input sensed via the one or more cameras.

20. A method as described in claim 14, further comprising:
causing a visual representation of the portion of the buildable product to be displayed;
recognizing a manipulation of the visual representation received via a gesture-based input sensed with the one or more cameras; and
changing a visual perspective of the visual representation responsive to the manipulation
